(19) United States
(12) Patent Application Publication
(10) Pub. No.: US 2008/0247315 A1
(43) Pub. Date: Oct. 9, 2008

(54) Flooding of Data Packets in a Switching Telecommunications Device

(75) Inventors: Aharon Lavon, Lod (IL); Amit Cohen, Nes Ziona (IL); Ido Shargil, Shoham (IL)

Correspondence Address: BROWDY AND NEIMARK, P.L.L.C.;624 NINTH STREET, NW, SUITE 300, WASHINGTON, DC, 20001-5303, US

(73) Assignee: ECI TELECOM LTD., Petach Tikva (IL)

(21) Appl. No.: 12/093,430

(22) PCT Filed: Nov. 2, 2006
(86) PCT No.: PCT/IL2006/001267

§ 371 Date: May 12, 2008

(30) Foreign Application Priority Data
Nov. 10, 2005 (IL) 171882

(51) Int. Cl. H04L 12/56

(52) U.S. Cl. 370/235

(57) ABSTRACT

A technique is described for flooding data packets in a telecommunication switching device comprising a plurality of interface blades. The technique comprises arranging a logical ring by interconnecting a group of interface blades of the telecommunication switching device, wherein the interface blades of the group comprise all leaf ports of the telecommunication device. Upon receiving a packet with un known destination at a particular interface blade of the logical ring, the packet is forwarded along the logical ring using unicast transmission. At each of the interface blades holding at least one leaf port, the packet is fed to at least one leaf port of the interface blade. The technique both ensures that the packet will be received at its destination via any of the leaf ports, and prevents burst flooding in the telecommunication switching device.

### FIELD OF THE INVENTION

The present invention relates to a technique for flooding of data packets in switching telecommunication devices.

### BACKGROUND OF THE INVENTION

A switching telecommunication device is comprised of a number, say N, of ports and a switching core, where each port is able to transmit/receive datagrams to/from the switching core, and the switching core performs routing of the datagrams it receives from the originating port to the destination port (or ports). The switching core might have some blocking limitations.

A datagram may be destined to a single, multiple or all ports of the device. When a datagram is destined to more than a single port, its forwarding process is called ‘flooding’. The phenomenon of flooding in telecommunication devices is well known.

The telecommunication switching device is usually comprised of a switching core (a cross-connection device, a switching fabric or matrix SW) and interface blades (packet processing blades), each hosting to single or multiple ports. A leaf or a leaf port of an interface blade is to be understood as the port, which is directly or indirectly connected to a source or a destination of the packet processed at the blade.

A usual way to implement flooding is normally by using multicast transmission, according to which the source of the packet needs to duplicate (or multiply) the packet and send it, via the switching device, to the leaf ports. In a telecommunication device that is comprised of 20 interface blades with 20 leaf ports, the process will result in the generation of 20 identical copies of a packet which will create a burst blocking the link between the source interface blade and the switching fabric (device) SW.

FIG. 1 schematically illustrates the regular way of flooding a switching device by data packets, using a switching core in the form of a switching fabric SW. In the drawing, the interface blade 1 floods a packet to interface blades 3, 4, 5 and 7 via the SW fabric. The way to do it is to multiply the packet 4 times, hence a burst of four packets marked by an ellipse is transmitted over the internal physical link between the interface blade 1 (IB1) and the switching fabric SW.

### SUMMARY OF THE INVENTION

It is therefore an object of the present invention to provide a technique for preventing excessive flooding of internal links in a telecommunication switching device. It is also an object to provide a mechanism, which is simple to implement for managing the distribution of flooded traffic to all the leaves (leaf ports) that are the targets of such traffic.

According to a first aspect of the invention, the above object can be achieved by a method of flooding data packets in a telecommunication switching device comprising a plurality of interface blades, the method comprising:
arranging a logical ring by interconnecting a group of interface blades of the telecommunication switching device (directly or indirectly), wherein the interface blades of the group comprise all leaf ports of the telecommunication device, said leaf ports being directly or indirectly connected to destinations of packets to be flooded,
upon receiving at a particular interface blade of the logical ring a packet with unknown destination, forwarding said packet along said logical ring using a unicast transmission, while
at each of the interface blades holding at least one leaf port, feeding the packet to said at least one leaf port of the interface blade, thereby ensuring that the packet will be received at its destination via any of the leaf ports, and preventing burst flooding in the telecommunication switching device.

The connected interface blades can be referred to as peers.

In other words, the logical ring interconnects all interface blades of the network, that comprise these so-called leaf ports (a port directly or indirectly connected to users of the network)—i.e., such interface blades that must participate in the flooding process. It should be noted that the ring, comprising all such interface blades, may additionally comprise the ones without the leaf ports.

The logical ring can be arranged by logical connections between the interface blades (the preferable configuration), by physical connections there-between, or by a number of logical and a number of physical connections.

In practice, and most preferably, the method comprises arranging said logical ring by providing a switching core SW (such as a switching fabric), and by arranging logical connections between the interface blades (or peers) of the group to connect them into a ring configuration; a logical connection between a pair of adjacent blades in the ring being formed by providing physical connections between said adjacent blades via the SW core. If the telecommunication switching device is illustrated with its SW core surrounded by its interface blades, the physical connections between the blades via the SW core form a star-like configuration (though being “unfolded”, such physical connections would form a ring). It goes without saying that more than one inter-connected SWs can be used in such a telecommunication device to form a logical ring.

The method further comprises attaching a ring identifier tag to a packet that has arrived to an interface blade being a member of the ring whenever destination of the packet is not recognized by the interface blade, the ring identifier tag allowing the packet to be recognized by any one of said interface blades of the ring as the packet to be forwarded along the ring and be dispatched (fed) to all leaf ports of the ring. For example, the packet can be provided with a header comprising the ring identifier tag which defines the ring and does not change while transmitting the packet along the ring, and a local destination portion which defines destination of the packet on a ring segment between two neighbor blades. The local destination portion of the header is appended to the packet at each blade, and is changed from blade to blade.

Still preferably, in addition to said ring (which can be called a main ring), the method may comprise providing an auxiliary ring interconnecting the interface blades comprising all the leaf ports of the network (actually, the same blades as the main ring), for forwarding the packet from one blade to another along the auxiliary ring in a direction opposite to the direction of forwarding the packet in the main ring.

The method, where a dual ring is provided formed from the two opposite rings, allows using said two rings for protection of the flooding process, for example in the following manner.

The auxiliary ring can be arranged in advance by defining logical connections thereof, but transmission of packets along this auxiliary ring is preferably initiated when a fault is detected in the main ring: for example, when one of the blades of the main ring fails (say, a card is removed from the shelf, or a physical connection is not in order). Usually, a message of a failed blade/connection is received at any of the neighbor blades and/or at a Central Processor Unit of the telecommunication device. Upon a failure, the auxiliary ring is initiated—i.e. the packet transmission starts via the auxiliary ring, while the packet transmission along the main ring may be maintained. Sections of the two rings remaining after failure of one of the blades may work together and allow reaching all remaining blades of the rings having leaf ports via one and/or another of the rings.

In other words, when the two rings (i.e., two respective portions of the rings remaining upon a fault) are present, there are two optional operation modes. The first mode is to use one ring for transmission and the other still for protection, thus any packet arrives at the destination blade from a single ring. The second mode is to use both rings for the transmission. With that option, the destination blade may receive a packet twice (from both rings), and the blade needs to keep track of the received packets so as to use a single copy.

The method may optionally comprise forming said one or two rings from scratch upon failure of one or more said blades or connections. That can be provided with the aid of the Central Processor Unit of the device or by an external management system, by omitting the failed blade from the ring (rings).

Preferably, in order to prevent endless circulation of packets along the ring, the method comprises steps for removing, from said one or both of the rings, packets which have made their complete route along a ring. That can be provided in many ways, in each of the rings. For example, discard of such packets can be performed at an originating or source interface blade of the ring, (the blade to which a packet with unknown address has arrived), or at the last blade of the ring neighboring to the originating blade. For example, when the originating blade receives the packet in which it recognizes itself as the source, the originating blade discards the packet from the ring.

To prevent a scenario in which (because of a malfunction, or for any other reason) the blade that is responsible to remove the packet from the ring cannot do that, a TTL (time to live) mechanism may be implemented. According to this mechanism, the packet header is provided with a TTL counter which is set by the source blade to a pre-calculated value ensuring that the packet will be received by all the blades on the ring, but will not travel endlessly over the ring in the case of a single malfunction. For example, the source blade may set this counter to a value corresponding to the maximum number of blades on the ring, and each node that receives the packet will decrement that value by 1. If a blade detects the counter expired (e.g., the value is zero), it will remove the packet from the ring.

There is also provided a telecommunication switching device capable of implementing the above-defined method.

According to a further aspect of the invention, there is provided a software product comprising computer implementable instructions and/or data which, being run on a computer, allow carrying out the method according to the above-described principles. Further, the application is also intended to protect a carrier medium comprising the above-mentioned software product.

According to yet another aspect of the invention, there is provided a control system, capable of implementing the inventive method, for example by utilizing the mentioned software product. The control system can be, say, in the form of a Processing Unit (Centralized or distributed) monitoring and controlling the device, for example the SW and the blades of the device. The blades can be in the form of interface cards connectable to other systems/networks.

### BRIEF DESCRIPTION OF THE DRAWINGS

The invention will further be illustrated and described with reference to the following non-limiting drawings, in which:

FIG. 1 is a diagram illustrating a conventional way of flooding a telecommunication device with packets.

FIG. 2 schematically illustrates an exemplary embodiment of a single ring arranged between a group of blades according to the invention, for non-burst flooding the network with data packets.

FIG. 3 schematically illustrates an exemplary embodiment of a double ring formed between a group of blades via a switching fabric SW.

FIG. 4 schematically illustrates protective functions of the double ring shown in FIG. 3.

FIG. 5 schematically illustrates yet another embodiment of the telecommunication switching device where the proposed method can be implemented.

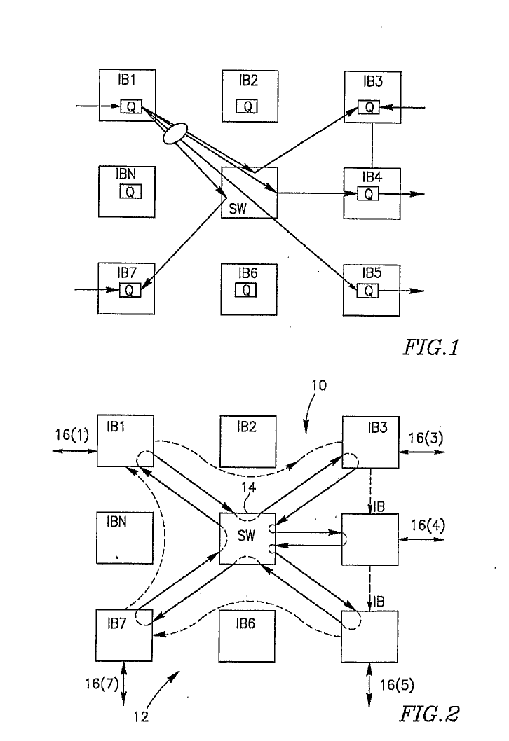

### DETAILED DESCRIPTION OF THE INVENTION

FIG. 2 illustrates one version of the proposed method, where a ring 10 is formed in a telecommunication device 12 having a switching core SW 14 by interconnecting interface blades of the device—IB1, IB3 to IB5 and IB7—into a ring-like configuration. The ring is formed from such blades that comprise a so-called leaf port (a port directly or indirectly connected to users)—i.e., comprises all blades of the telecommunication device that must participate in the flooding process. In the blade 1, such a leaf port is illustrated as an arrow marked 16(1). In the blade 3, its leaf port is marked 16(3), and so on.

Each blade comprises a memory block (a processor of the blade or a distributed processor of the network), and the memory block includes one or more structures for managing queues (one such queue management structure is shown and marked as “Q”). The memory block of a blade also comprises a dynamically formed destination table (not shown).

In the illustrated example, the logical ring 10 (shown with dotted arrows) is formed by using logical indirect connections defined between blades (IB) 1,3-5,7 via the switching core (fabric) SW 14. The logical (dotted) connections between the blades are implemented by physical connections shown by solid arrows between the blades and the SW core. The solid arrows form a star-like configuration, which, if unfolded, turns into a ring. Alternatively the logical ring 10 could be formed if one or more direct physical spans were formed between the blades, though such a solution does not seem optimal.

Any packet incoming one of the blades being members of the ring 10 and having a destination address unknown to the internal table of the blade, will be marked with a ring identifying tag and be forwarded along the ring 10 in a chain like manner, from one blade to another, so that the marked packet can reach each and any of the blades of the ring and be stripped off at each of them via the corresponding leaf port towards a client of the network connected to the telecommunication device. Forwarding the packet from one blade to another can be performed by using a so-called local sub-tag; the sub-tag may be changed at each blade to forward the packet to the next blade.

The described procedure ensures the full flooding in the switching telecommunication device 12, upon which the packet will definitely find its “destination blade and port”; simultaneously, its source address will be registered in internal tables of the blades to facilitate routing of any newly arriving packets.

Preferably, if one of the blades (peers) or physical connections fails in such a configuration, a new ring is formed by a control plane of the system (e.g., by a central processor unit of the device, by a network manager). The new ring should connect the blades comprising all the leaf ports remaining active after the failure.

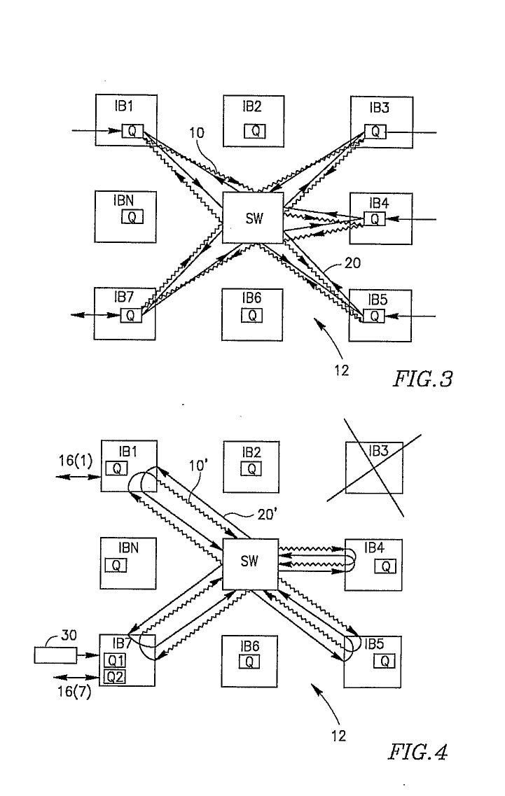

FIG. 3 illustrates another exemplary embodiment of an arrangement for performing flooding in the telecommunication device 12 with a switch core SW. Two logical rings (10 and 20) for transmitting packets there-along in mutually opposite directions, are defined in the device 12 to include the blades that comprise all leaf ports of the device. Let one of the rings be called main (say, ring 10) and the other (20) be called auxiliary. The main ring 10 is illustrated by waved arrows; the auxiliary ring 20 is shown using solid arrows.

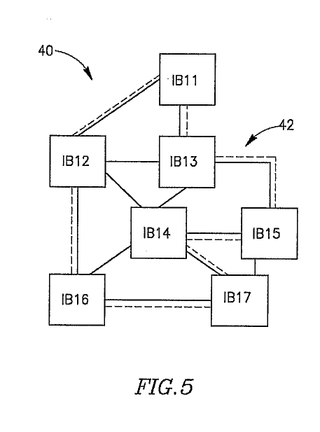

The two rings 10 and 20 in this figure are formed exclusively by defining indirect logical spans, via a switching device, to connect adjacent blades of the ring(s). It should be noted that more than one interconnected SW fabrics can be used for this purpose, though only one such SW is shown. The advantage of such a dual ring is in that it may allow protection of the flooding traffic in case one of the blades being a member of the ring fails, or one of the connections in the ring fails. In case of a single ring, the flooding becomes impossible not only to a failed blade, but also to blades following the failed one. If two “opposite direction” rings are formed, the failed blade is excluded, while any other blade comprising a leaf port and being a member of the rings can be reached via one of the remaining portions of the rings (i.e., from one or another side). The flooding process in such a situation is further illustrated in FIG. 4.

FIG. 4 schematically shows a case when blade IB3 of the telecommunication device 12 has failed. Connections defined between the blade 3 and SW also fail. The drawing shows that the remaining sections of the rings 10 and 20 form two logical rings 10′ and 20′ respectively. To perform such a transformation, the Central Processing means of the device should participate.

As has been mentioned in the summary, the auxiliary ring (20) can be pre-defined but not used for transmitting packets there-through when the main ring is in order. If a failure is detected in the main ring, the remaining portions of the two rings start being used simultaneously in this example. The remaining sections of the main ring 10 transmit packets in the clockwise direction, and the remaining portion of the ring 20—in the counter-clockwise direction.

At each blade, one queue managing structure “Q” is shown, though two queue structures can be arranged and be in use in a blade when two rings 10 and 20 are active together.

Let a packet 30 arrives to blade 7 via its leaf port 16 (7), and the packet's destination is unknown to IB7. Due to the fault of blade 3, and according to the invention, the packet 30 (usually, upon being held in a queue) will be transmitted from blade 7 in two opposite directions, along the two active rings 10′ (waved arrows) and 20′ (solid arrows). In this example, two queue management structures Q1 and Q2 are activated in the blade 7 being a “source” element.

As a result of packet transmission via the remaining portions of the dual ring, the blade 1 will be reached by the packet 30 via connections of the clock-wise main ring 10′, and other remaining blades 4 and 5 will be reached via the counter-clockwise auxiliary ring 20′.

FIG. 5 illustrates yet another embodiment 40 of a telecommunication switching device, which comprises a number of interface blades IB11-IB17 interconnected with one another in a mesh-like manner (physical links are shown by solid lines). The drawing demonstrates that the proposed method can be implemented on such a device, too. One or more logical rings can be arranged in the device to include the interface blades comprising leaf ports. FIG. 5 shows, by dotted lines, a single logical ring 42 enveloping all the blades of the device.

It should be appreciated that other embodiments of the telecommunication switching devices can be used for implementation of the proposed method, and modified versions of the method could be proposed which should be considered part of the invention. The invention is generally defined by the following claims.

1. A method of flooding data packets in a telecommunication switching device comprising a plurality of interface blades, the method comprising:
arranging a logical ring by interconnecting a group of interface blades of the telecommunication switching device, wherein the interface blades of the group comprise all leaf ports of the telecommunication device,
upon receiving a packet with unknown destination at a particular interface blade of the logical ring, forwarding said packet along said logical ring using a unicast transmission, while
at each of the interface blades holding at least one leaf port, feeding the packet to said at least one leaf port of the interface blade, thereby ensuring that the packet be received at its destination via any of the leaf ports, and preventing burst flooding in the telecommunication switching device.

2. The method according to claim 1, wherein the method comprises arranging said logical ring in the telecommunication device with a switching core SW, and wherein a logical connection formed between a pair of said interface blades adjacent in the logical ring comprises physical connections interconnecting said pair of the blades via the switching core SW.

3. The method according to claim 1, comprising a step of appending to said packet a ring identifier tag allowing the packet to be forwarded along said ring and be dispatched to all said leaf ports.

4. The method according to claim 1, further comprising providing an auxiliary ring in addition to said ring called a main ring; the auxiliary ring interconnects the interface blades comprising all the leaf ports of the telecommunication device for forwarding said packet from one of said blades to another along the auxiliary ring in a direction opposite to the direction of forwarding the packet in the main ring.

5. The method according to claim 4, comprising arranging said auxiliary ring in advance, and activating said auxiliary ring whenever any connection and/or interface blade of the main ring fails, by transmitting packets along the auxiliary ring simultaneously with transmitting said packets along the main ring.

6. The method according to claim 1, comprising forming a new ring in the network if a failed connection and/or a failed interface blade is detected in the ring, by omitting said failed connection and/or interface blade from the ring.

7. The method according to claim 1, further comprising a step of discarding the packet upon said packet had made its complete route along said main or auxiliary ring, or its TTL counter has expired.

8. A telecommunication switching device comprising a switching core and a number of interface blades, capable of implementing the method according to claim 1.

9. A carrier medium storing a software product comprising computer implementable instructions and/or data which, being run on a computer, allow carrying out the method according to claim 1.

10. (canceled)

11. A control system for a telecommunication network device, capable of controlling said device according to the method as claimed in claim 1.
